(19) United States
(12) Patent Application Publication
(10) Pub. No.: US 2026/0227628 A1
(43) Pub. Date: Aug. 6, 2026

(54) OPTICAL DEVICE FOR AUGMENTED REALITY HAVING AN EXPANDED FIELD OF VIEW AND EYEBOX

(71) Applicant: LETINAR CO., LTD, Anyang-si, Gyeonggi-do (KR)

(72) Inventor: Jeong Hun HA, Seoul (KR)

(73) Assignee: LETINAR CO., LTD, Anyang-si, Gyeonggi-do (KR)

(21) Appl. No.: 19/154,728

(22) PCT Filed: Jan. 24, 2024
(86) PCT No.: PCT/KR2024/001103

§ 371 Date: Aug. 7, 2025

(30) Foreign Application Priority Data
Feb. 9, 2023 (KR) 10-2023-0017407

(51) Int. Cl. G02B 27/01

(52) U.S. Cl. CPC G02B 27/0101; G02B 2027/0123

(57) ABSTRACT

The present invention provides an optical device for augmented reality having an expanded field of view and eyebox, the optical device including: an image output unit including a display unit configured to output virtual image light, and a light conversion unit configured to convert and then output the virtual image light according to preset requirements; an optical means configured to allow the virtual image light, output from the image output unit, to propagate through the inside thereof, and to transmit real object image light therethrough toward a user's pupil; and a plurality of optical elements arranged in the optical means to transfer the virtual image light, transferred from the image output unit, toward the user's pupil; wherein each of the plurality of optical elements includes a first reflective surface and a second reflective surface; and wherein the first and second reflective surfaces are arranged at an inclination angle.

### TECHNICAL FIELD

The present invention relates to an optical device for augmented reality, and more particularly, to an optical device for augmented reality capable of expanding the field of view and eye box.

### BACKGROUND ART

Augmented reality (AR) refers to technology that superimposes virtual images on real images of the real world and then provides resulting images, thereby providing the virtual image information augmented from visual information of the real world to users, as is well known.

In order to provide augmented reality, there is required an optical combiner that enables the simultaneous observation of virtual images and real images of the real world. As such optical combiners, there are known half mirror-type combiners and holographic/diffractive optical element (HOE/DOE)-type combiners.

Meanwhile, the present applicant has developed a technology for arranging small optical elements in the form of a pin mirror, which is smaller than the average human pupil, in an optical means such as a lens as an optical synthesizer (see the Related Art Document).

FIGS. 1 to 3 show a side view, perspective view, and front view, respectively, of an optical device 100 for augmented reality disclosed in the Related Art Document.

Referring to FIGS. 1 to 3, the optical device 100 for augmented reality includes an optical means 10 and optical elements 20.

The optical means 10 performs the function of transmitting the real object image light, which is the image light output from an object in the real world, therethrough to a pupil 40. Furthermore, the optical means 10 functions as a waveguide that allows the virtual image light, output from the image output unit 30, to propagate through the inside of the optical means 10 and be output to the pupil 40.

The optical means 10 may be made of a transparent resin material like a lens of glasses, and may be fixed by a frame (not shown) such as the frame of glasses.

The image output unit 30 is a means that outputs virtual image light, and may include a display unit that displays virtual images on a screen and outputs virtual image light corresponding to the displayed virtual images, and a light conversion unit that converts and then outputs the image light output from the display unit according to preset design requirements.

The optical elements 20 transfer the virtual image light, output from the image output unit 30, toward a user's pupil 40.

The optical elements 20 may be plural in number, in which case the individual optical elements 20 are embedded and arranged inside the optical means 10 with intervals therebetween. For example, as shown in FIG. 3, the optical elements 20 may be embedded and arranged inside the optical means 10 so that they appear as a two-dimensional array when viewed from the front.

In this case, the plurality of optical elements 20 may be collectively referred to as an optical element array 20G, and may provide a see-through function in such a manner that the actual object image light is transferred to the pupil 40 through the spaces between the optical elements 20.

The optical elements 20 are each formed to be smaller than the average human pupil size, i.e., 8 mm or less, preferably 4 mm or less, when the optical device 100 is placed in front of the pupil 40 and then viewed. This may make the depth of field for light incident on the pupil 40 considerably deeper.

The depth of field refers to a range within which an image for augmented reality is recognized as being in focus. As the depth of field increases, the range of focal lengths for virtual images widens correspondingly. Accordingly, even when a user changes the focal length for the real world while gazing at the real world, the user always recognizes an image for augmented reality as being in focus regardless of such changes. This may be viewed as a type of pinhole effect.

This optical device 100 for augmented reality has the advantages of making the device compact and lightweight while widening the field of view (FoV) and expanding the eyebox.

When the optical device 100 for augmented reality is placed in front of the pupil 40, the field of view and the eyebox in the horizontal-axis direction are determined by the length of a light conversion unit included in the image output unit 30, and the field of view and the eyebox in the vertical-axis direction are determined by the arrangement structure of the optical elements 20.

Accordingly, in order to expand the field of view and the eyebox in the horizontal-axis direction, a light conversion unit that is longer in the horizontal-axis direction needs to be employed. However, a problem arises in that as the length of the light conversion unit increases, form factors such as size, weight, and volume become larger and also the design of the optical path becomes more complicated.

Therefore, the optical device 100 for augmented reality configured as described above has limitations in expanding the field of view and the eyebox in the horizontal-axis direction.

### Related Art Document

Korean Patent No. 10-2192942 (published on Dec. 18, 2020)

### DISCLOSURE

### Technical Problem

An object of the present invention is to provide an optical device for augmented reality that may expand the field of view and the eyebox.

In particular, an object of the present invention is to expand the field of view and the eyebox in the horizontal-axis direction of an optical device for augmented reality.

In addition, an object of the present invention is to provide an optical device for augmented reality that may make the device compact and lightweight while expanding the field of view and the eyebox.

### Technical Solution

According to an embodiment of the present invention, there is provided an optical device for augmented reality having an expanded field of view and eyebox, the optical device including: an image output unit including a display unit configured to output virtual image light, and a light conversion unit configured to convert and then output the virtual image light according to preset requirements; an optical means configured to allow the virtual image light, output from the image output unit, to propagate through the inside thereof, and to transmit real object image light therethrough toward a user's pupil; and a plurality of optical elements arranged in the optical means to transfer the virtual image light, transferred from the image output unit, toward the user's pupil; wherein each of the plurality of optical elements includes a first reflective surface and a second reflective surface, which are a pair of reflective surfaces arranged to be inclined with respect to each other; and wherein the first and second reflective surfaces are arranged at an inclination angle such that each of the first and second reflective surfaces transfers virtual image light, transferred from the image output unit, to the other reflective surface and transfers virtual image light, transferred from the other reflective surface, toward the user's pupil.

In this case, the inclination angle between the first and second reflective surfaces may be between 60° and 120°.

As one embodiment, the inclination angle between the first and second reflective surfaces may be 90°.

Furthermore, the first and second reflective surfaces may be arranged with a gap therebetween.

Furthermore, the plurality of optical elements may be formed such that, when the optical device for augmented reality is placed in front of the pupil and then viewed, among the first and second reflective surfaces, the heights of those located in the direction from the center toward one side along the horizontal-axis gradually increase along that direction.

Furthermore, the plurality of optical elements may be formed such that, when the optical device for augmented reality is placed in front of the pupil and then viewed, among the first and second reflective surfaces, the heights of those opposite to reflective surfaces located in the direction from the center toward one side along the horizontal-axis gradually decrease along that direction.

As one embodiment, the plurality of optical elements may be arranged at intervals such that they appear as a two-dimensional array when the optical device for augmented reality is placed in front of the pupil and then viewed.

Furthermore, the plurality of optical elements may be arranged such that, when the optical device for augmented reality is placed in front of the pupil and then viewed, the area of one of first and second reflective surfaces of at least some of the plurality of optical elements appears smaller than that of the other surface.

Furthermore, among the plurality of optical elements, optical elements arranged in the central portion when the optical device for augmented reality is placed in front of the pupil and then viewed may be arranged such that the areas of the first and second reflective surfaces may appear to be the same, and at least some of optical elements other than the optical elements arranged in the central portion may be arranged in a form obtained by rotating the optical elements arranged in the central portion around boundary lines between the first and second reflective surfaces.

Furthermore, the optical means may have a first surface configured such that virtual image light and real object image light are output toward the user's pupil therethrough, and a second surface configured such that it faces the first surface and real object image light is incident thereon; and the virtual image light output from the image output unit may be reflected by total internal reflection on the second surface of the optical means and transferred to the optical elements.

Furthermore, each of the plurality of optical elements may be arranged to be inclined inside the optical means so that it can transfer the virtual image light, transferred by total internal reflection on the second surface of the optical means, to the user's pupil.

As one embodiment, each of the plurality of optical elements may be 4 mm or less in size when the optical device for augmented reality is placed in front of the pupil and then viewed.

Furthermore, each of the plurality of optical elements may be a reflective means that reflects incident light.

Furthermore, at least some of the plurality of optical elements may half mirrors that transmit a portion of incident light therethrough and reflect a portion of the incident light.

Furthermore, at least some of the plurality of optical elements may each be formed of any one of a refractive element, a diffractive element, and a holographic element, or a combination thereof.

According to another aspect of the present invention, there is provided an optical device for augmented reality having an expanded field of view and eyebox, the optical device including: an image output unit including a display unit configured to output virtual image light; an optical means configured to allow the virtual image light, output from the image output unit, to propagate through the inside thereof, and to transmit real object image light therethrough toward a user's pupil; an auxiliary optical element arranged in the optical means, and configured to convert the virtual image light, output from the image output unit, according to preset requirements and to output the virtual image light so that it is transferred to a plurality of optical elements; and the plurality of optical elements arranged in the optical means to transfer the virtual image light, transferred from the auxiliary optical element, toward the user's pupil; wherein each of the plurality of optical elements includes a first reflective surface and a second reflective surface, which are a pair of reflective surfaces arranged to be inclined with respect to each other; and wherein the first and second reflective surfaces are arranged at an inclination angle such that each of the first and second reflective surfaces transfers virtual image light, transferred from the image output unit, to the other reflective surface and transfers virtual image light, transferred from the other reflective surface, toward the user's pupil.

In this case, the auxiliary optical element may be embedded and arranged inside the optical means in order to face the image output unit.

Furthermore, the optical means may have a first surface configured such that virtual image light and real object image light are output toward the user's pupil therethrough, and a second surface configured such that it faces the first surface and real object image light is incident thereon; the virtual image light output from the image output unit may be reflected by total internal reflection on the second surface of the optical means and transferred to the auxiliary optical element; and the virtual image light output from the auxiliary optical element may be reflected by total internal reflection on the second surface of the optical means and transferred to the optical elements.

Furthermore, the plurality of optical elements may be arranged to be inclined inside the optical means so that they can transfer virtual image light, transferred by total internal reflection on the second surface of the optical means, to the user's pupil.

Furthermore, the auxiliary optical element may be a reflective means that reflects incident light.

Furthermore, the auxiliary optical element may be a half mirror that transmits a portion of incident light therethrough and reflects a portion of the incident light.

Furthermore, the auxiliary optical element may be formed of any one of a refractive element, a diffractive element, and a holographic element, or a combination thereof.

Furthermore, the auxiliary optical element may be formed such that, when the optical device for augmented reality is placed in front of the pupil and then viewed, the auxiliary optical element is formed to extend in order to become closer to the image output unit in a direction from the central portion thereof toward the left and right ends thereof.

As one embodiment, the inclination angle between the first and second reflective surfaces may be between 60° and 120°.

Furthermore, the inclination angle between the first and second reflective surfaces may be 90°.

Furthermore, the first and second reflective surfaces may be arranged with a gap therebetween.

Furthermore, the plurality of optical elements may be formed such that, when the optical device for augmented reality is placed in front of the pupil and then viewed, among the first and second reflective surfaces, the heights of those located in the direction from the center toward one side along the horizontal-axis gradually increase along that direction.

Furthermore, the plurality of optical elements may be formed such that, when the optical device for augmented reality is placed in front of the pupil and then viewed, among the first and second reflective surfaces, the heights of those opposite to reflective surfaces located in the direction from the center toward one side along the horizontal-axis gradually decrease along that direction.

Furthermore, the plurality of optical elements may be arranged at intervals such that they appear as a two-dimensional array when the optical device for augmented reality is placed in front of the pupil and then viewed.

Furthermore, the plurality of optical elements may be arranged such that, when the optical device for augmented reality is placed in front of the pupil and then viewed, the area of one of first and second reflective surfaces of at least some of the plurality of optical elements appears smaller than that of the other surface.

Furthermore, among the plurality of optical elements, optical elements arranged in the central portion when the optical device for augmented reality is placed in front of the pupil and then viewed may be arranged such that the areas of the first and second reflective surfaces appear to be the same, and at least some of optical elements other than the optical elements arranged in the central portion may be arranged in a form obtained by rotating the optical elements arranged in the central portion around boundary lines between the first and second reflective surfaces.

As one embodiment, each of the plurality of optical elements may be 4 mm or less in size when the optical device for augmented reality is placed in front of the pupil and then viewed.

Furthermore, the plurality of optical elements may be reflective means that reflect incident light.

Furthermore, at least some of the plurality of optical elements may be half mirrors that transmit a portion of incident light therethrough and reflect a portion of the incident light.

Furthermore, at least some of the plurality of optical elements may each be formed of any one of a refractive element, a diffractive element, and a holographic element, or combination thereof.

According to another aspect of the present invention, there is provided a glasses-type augmented reality provision apparatus, including: optical devices for augmented reality set forth above; a frame part configured such that the optical devices for augmented reality are fixed thereto; and fixation parts configured to be coupled to the frame part and fix the optical devices for augmented reality so that they can be worn on a user's face.

### Advantageous Effects

According to the present invention, there may be provided the optical device for augmented reality that may expand the field of view and the eyebox.

In particular, the present invention may expand the field of view and the eyebox in the horizontal-axis direction of the optical device for augmented reality.

In addition, the present invention may provide the optical device for augmented reality that may make the device compact and lightweight while expanding the field of view and the eyebox.

### DESCRIPTION OF DRAWINGS

FIGS. 1 to 3 show a side view, perspective view, and front view, respectively, of an optical device 100 for augmented reality disclosed in the Related Art Document;

FIGS. 4 to 6 show a side view, perspective view, and front view, respectively, of an optical device 200 for augmented reality having an expanded eyebox according to the present invention;

FIGS. 7 to 9 are diagrams illustrating the configuration and operation of each of the optical elements 20, wherein FIG. 7 is a perspective view of the optical element 20, FIG. 8 is a plan view of the optical element 20, and FIG. 9 is a front view of the optical element 20;

FIG. 10 is a perspective view of an optical device 200 showing the optical paths of virtual image light in optical elements 20 at both ends of the horizontal-axis direction;

FIG. 11 is a diagram illustrating the tilting arrangement structure of optical elements 20, which shows a sectional view of the optical elements 20 viewed in the direction in which the boundary lines between the first and second reflective surfaces 20A and 20B of the optical elements 20 extend.

FIGS. 12 and 13 are diagrams showing the effects of the field of view and eyebox of the optical device 200 according to the present invention;

FIGS. 14 to 16 show a side view, perspective view, and front view, respectively, of an optical device 300 according to another embodiment of the present invention; and

FIGS. 17 and 18 are diagrams showing an embodiment of a glasses-type augmented reality provision apparatus 400.

### BEST MODE

Embodiments of the present invention will be described in detail below with reference to the accompanying drawings.

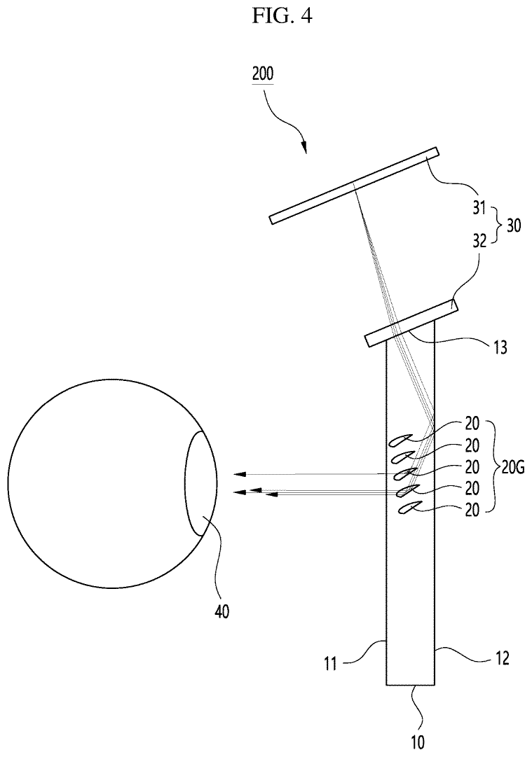

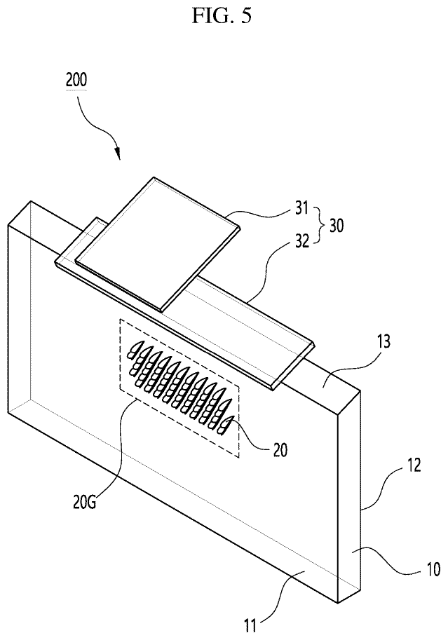

FIGS. 4 to 6 show a side view, perspective view, and front view, respectively, of an optical device 200 for augmented reality having an expanded eyebox (hereinafter simply referred to as the “optical device 200”) according to the present invention.

Referring to FIGS. 4 to 6, the optical device 200 includes an optical means 10, optical elements 20, and an image output unit 30.

The optical means 10 is a means that transmits the real object image light, output from a real object present in the real world, toward a user's pupil 40.

Furthermore, the optical means 10 functions as a waveguide that allows the virtual image light, output from the image output unit 30, to propagate through the inside thereof and be output to the pupil 40.

The optical means 10 may be made of a transparent resin material or glass material, and the optical elements 20 are embedded and arranged inside the optical means 10 as will be described below.

The optical means 10 has a first surface 11 configured such that virtual image light and real object image light are output toward the pupil 40 of the user therethrough, and a second surface 12 disposed opposite the first surface 11 and configured such that real object image light enters therethrough.

Furthermore, the optical means 10 has a third surface 13 configured such that the virtual image light output from the image output unit 30 enters therethrough.

The image output unit 30 is a means that outputs virtual image light, which is image light corresponding to a virtual image. The virtual image refers to an image for augmented reality provided to a user, and may be a still image or a moving image.

The image output unit 30 may include a display unit 31, and a light conversion unit 32.

The display unit 31 is a device that displays virtual images and outputs virtual image light corresponding to the displayed virtual images, and may be, for example, a device such as a small LCD, OLED, or LCOS, or a micro LED.

The light conversion unit 32 is a means that converts and then outputs incident virtual image light according to preset conditions, such as an optical path and focal length, and may be, for example, a collimator that converts incident light into parallel light and outputs the parallel light.

Alternatively, the light conversion unit 32 may be a lens such as a convex lens or a concave lens that converts and then outputs incident light so that the virtual image can be enlarged or reduced according to preset design requirements.

Furthermore, the light conversion unit 32 may be a diffractive element utilizing diffraction such as a holographic optical element or a diffractive optical element, or a refractive element.

As shown in FIGS. 4 to 6, the display unit 31 and the light conversion unit 32 may be arranged at a distance from each other, but this is exemplary. They may have a different distance depending on design requirements, and may be arranged close to each other in some cases.

Since the image output unit 30 itself is not a direct target of the present invention and is known in the prior art, a detailed description thereof will be omitted here.

The optical elements 20 are arranged to transfer the virtual image light, transferred from the image output unit 30, to the pupil 40 of a user's eye, thereby performing the function of providing the user with a virtual image.

The optical elements 20 may be embedded and arranged inside the optical means 10, as shown in the drawing, but this is exemplary. They may be disposed on the outside (e.g., the surface) of the optical means 10.

Although only one optical element 20 may be used, it is preferable to provide a plurality of optical elements for the expansion of the field of view and the eyebox.

In the optical device 200 of the embodiment of FIGS. 4 to 6, when the optical device 200 is placed and viewed in front of the pupil 40, the plurality of optical elements 20 are arranged at intervals therebetween so that they appear as a two-dimensional array. The plurality of optical elements 20 may collectively be referred to as an optical element array 20G.

However, this is exemplary, and the plurality of optical elements 20 may be arranged in close contact with each other. Accordingly, they may have a shape similar to a shape in which one bar is arranged in each row or column when viewed from a distance.

It is preferable that the intervals between the optical elements 20 constituting the optical element array 20G be the same. However, it is obvious that the intervals between some of the optical elements 20 may be different.

The real object image light is transferred to the pupil 40 through the spaces formed by the intervals between the optical elements 20 constituting the optical element array 20G, thereby providing a so-called see-through function.

In the embodiment of FIGS. 4 to 6, the virtual image light output from the image output unit 30 is reflected by total internal reflection on the second surface 12 of the optical means 10 and transferred to the optical elements 20, and the optical elements 20 transfer the incident virtual image light to the pupil 40, so that the individual optical elements 20 are arranged at appropriate inclination angles inside the optical means 10 with this optical path taken into consideration.

That is, the individual optical elements 20 are arranged inside the optical means 10 at appropriate inclination angles with the relative locations of the image output unit 30 and the pupil 40 taken into consideration.

Meanwhile, each of the optical elements 20 in the present invention is characterized by including a pair of reflective surfaces, i.e., a first reflective surface 20A and a second reflective surface 20B, which are arranged to be inclined with respect to each other.

Furthermore, it is preferable that each of the optical elements 20 be a reflective means that reflects incident light.

Furthermore, it is preferable that each of the optical elements 20 be a full mirror, for example, made of metal, having a high reflectivity value of 100% or a value close thereto.

Furthermore, at least some of the optical elements 20 may be half mirrors that transmit a portion of incident light therethrough and reflect a portion of the incident light.

Furthermore, each of the optical elements 20 may be a diffractive element or a refractive element, as described above.

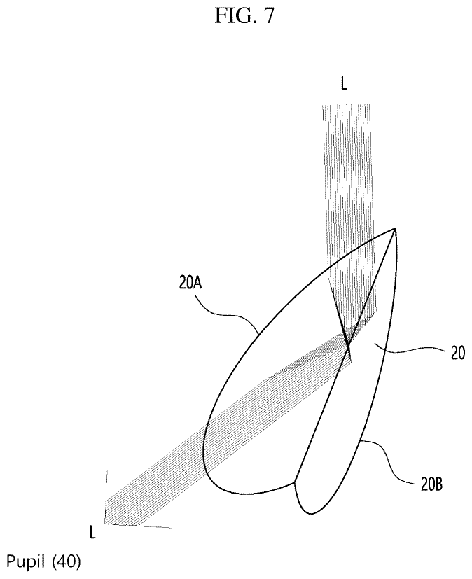

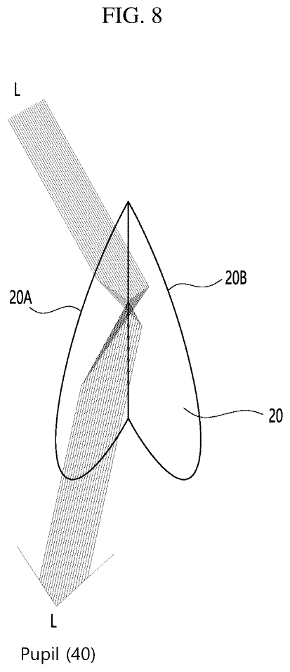

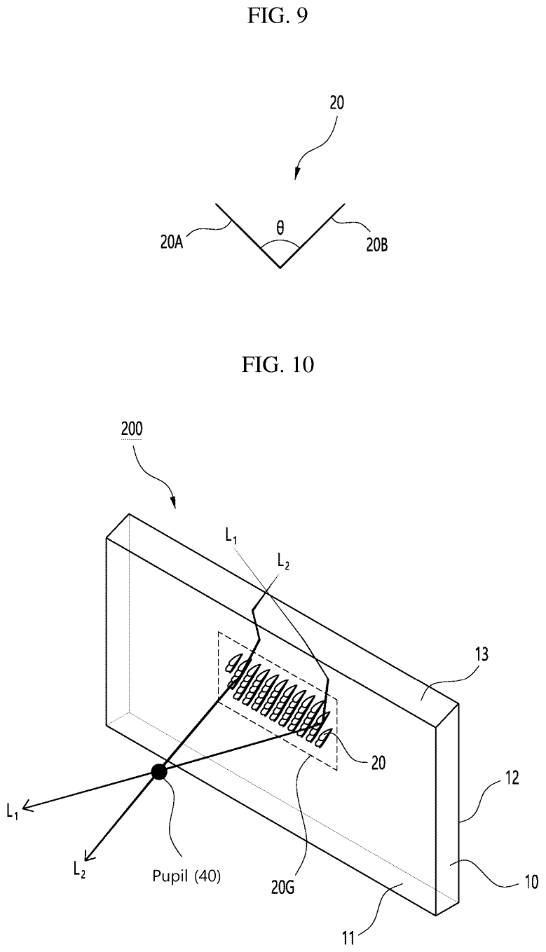

FIGS. 7 to 9 are diagrams illustrating the configuration and operation of each of the optical elements 20, wherein FIG. 7 is a perspective view of the optical element 20, FIG. 8 is a plan view of the optical element 20, and FIG. 9 is a front view of the optical element 20.

Referring to FIGS. 7 to 9, the optical element 20 includes the first and second reflective surfaces 20A and 20B, which are a pair of reflective surfaces arranged at an inclination angle θ with respect to each other.

The first and second reflective surfaces 20A and 20B are arranged at the inclination angle θ with respect to each other so that each of them transfers the virtual image light, transferred from the image output unit 30, to the other reflective surface and transfers the virtual image light, transferred from the other reflective surface, toward a user's pupil 40, as shown in the drawings.

That is, the first and second reflective surfaces 20A and 20B may be formed to have the inclination angle θ with respect to each other so that they appear in an “L” shape when viewed from the front, as shown in FIG. 9.

For example, the first and second reflective surfaces 20A and 20B may be formed to correspond to a shape in which the circular optical element 20 is bent at the inclination angle θ around a straight line passing through the center of the optical element 20.

The optical element 20 configured as described above functions as follows. That is, as shown in FIGS. 7 and 8, out of the virtual image light L incident on the one optical element 20, the virtual image light L incident on the first reflective surface 20A is reflected from the first reflective surface 20A and transferred to the second reflective surface 20B, and is then reflected again from the second reflective surface 20B and transferred to the pupil 40.

Furthermore, out of the virtual image light L incident on the one optical element 20, the virtual image light L incident on the second reflective surface 20B is reflected from the second reflective surface 20B and transferred to the first reflective surface 20A, and is then reflected again from the first reflective surface 20A and transferred to the pupil 40.

Accordingly, the incident direction of the virtual image light L incident on the one optical element 20 is changed around the boundary line between the first and second reflective surfaces 20A and 20B of the optical element 20 and is then output, as shown in FIG. 8.

FIG. 10 is a diagram illustrating the operation of the optical element 20 in more detail, which is a perspective view of an optical device 200 showing the optical paths of virtual image light in optical elements 20 at both ends of the horizontal-axis direction.

Referring to FIG. 10, as described above, the virtual image lights L₁ and L₂ output from the display unit 31 pass through the light conversion unit 32 and are incident on the optical means 10, and are then reflected by total internal reflection on the second surface 12 of the optical means 10 and transferred to the optical elements 20. However, it should be noted that the image output unit 30, i.e., the display unit 31 and the light conversion unit 32, is not shown here for ease of description.

In FIG. 10, the virtual image light L₁ is output from the left end of the display unit 31, and is then transferred to the optical element 20 arranged at the right end of the optical means 10 through an optical path such as that shown in FIG. 10. The virtual image light L₁ transferred to the optical element 20 is output toward the pupil 40 in the direction, changed from the incident direction, through the first and second reflective surfaces 20A and 20B, as described with reference to FIGS. 7 to 9.

Furthermore, the virtual image light L₂ is output from the right end of the display unit 31 and is transferred to the optical element 20 arranged at the left end of the optical means 10 through an optical path such as that shown in FIG. 10. The virtual image light L₂ transferred to the optical element 20 is also output toward the pupil 40 in a direction, changed from the incident direction, through the first and second reflective surfaces 20A and 20B, as described with reference to FIGS. 7 to 9.

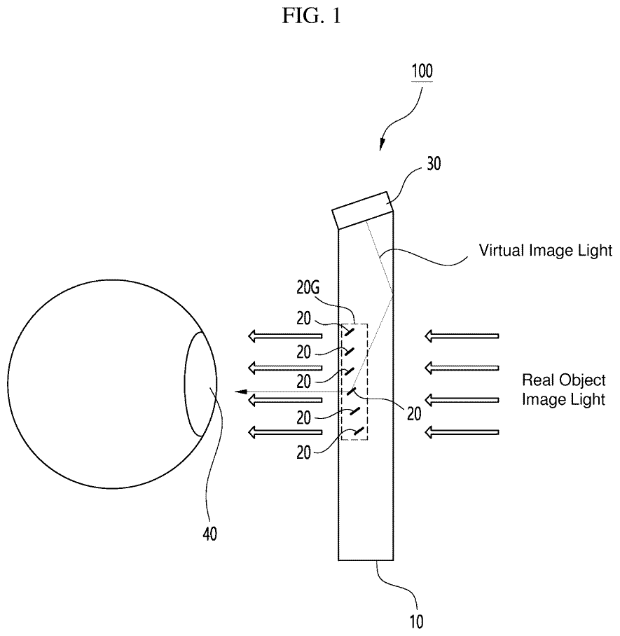

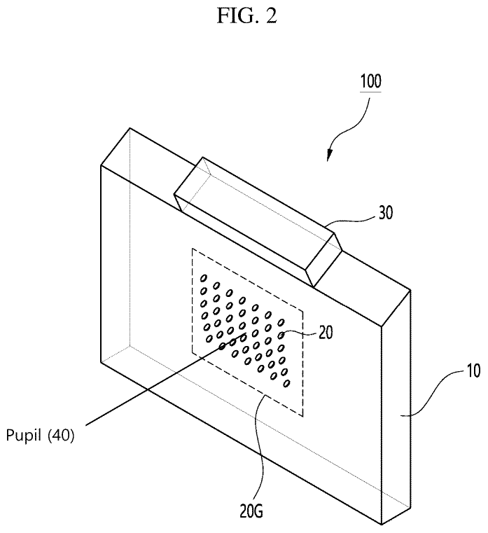

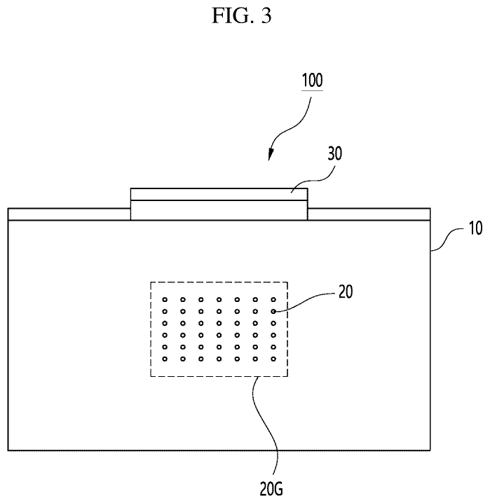

Accordingly, it can be seen that all the virtual image lights L1 and L2 output from both ends of the display unit 31 may be transferred to the pupil 40. This means that, when the optical device 200 is placed in front of the pupil 40, the field of view and eyebox of the optical device 200 in the horizontal-axis direction are significantly expanded compared to those of the conventional optical device 100 of FIGS. 1 to 3.

In the conventional optical device 100 of FIGS. 1 to 3, the optical elements 20 have a planar structure. Accordingly, there is the virtual image light that is not transferred to the pupil 40 out of the virtual image light incident on the optical elements 20 arranged at both ends. As a result, there is a limitation on the expansion of the field of view and the eyebox in the horizontal-axis direction.

In contrast, in the optical element 20 of the optical device 200 of FIGS. 4 to 10, the first and second reflective surfaces 20A and 20B of the optical element 20 are arranged at the inclination angle θ with respect to each other so that the virtual image light transferred from the image output unit 30 is transferred to the other reflective surface and the virtual image light transferred from the other reflective surface is transferred toward the user's pupil 40, as a described above. Accordingly, the direction of the incident virtual image light may be changed, and then the incident virtual image light may be output. As a result, the virtual image light at both ends in the horizontal-axis direction may be transferred to the pupil 40 without loss.

When this point is taken into consideration, it is preferable that among the first and second reflective surfaces 20A and 20B, the heights of those located in the direction from the center toward one side along the horizontal-axis gradually increase along that direction.

Furthermore, it is also possible that among the first and second reflective surfaces 20A and 20B, the heights of those opposite to reflective surfaces located in the direction from the center toward one side along the horizontal-axis gradually decrease along that direction.

For example, in FIG. 10, it is preferable to form so that the heights of the second reflective surfaces 20B, which are the reflective surface located in the direction from the center toward the right side gradually increase along that direction and the heights of the first reflective surfaces 20A gradually decrease along that direction.

Meanwhile, the inclination angle θ between the first and second reflective surfaces 20A and 20B may be between 60° and 120°, but is preferably 90°.

Furthermore, the optical element 20 is arranged inside the optical means 10 at an appropriate inclination angle by taking into consideration the relative locations of the image output unit 30 and the pupil 40. Accordingly, the inclination angle θ between the first and second reflective surfaces 20A and 20B may be determined by taking the above point into consideration.

Furthermore, it is obvious that the inclination angles θ of the optical elements 20 do not necessarily have to be the same and may be partially different from each other.

Furthermore, the first and second reflective surfaces 20A and 20B do not necessarily have to be connected to each other, and may be arranged with a gap therebetween. That is, the adjacent boundary surfaces of the first and second reflective surfaces 20A and 20B do not necessarily have to be connected to each other, and the boundary surfaces may be separated from each other. However, it may be necessary for the first and second reflective surfaces 20A and 20B to have an appropriate gap depending on another design requirement.

Meanwhile, unlike what is shown in FIGS. 7 to 9, the sizes of the first and second reflective surfaces 20A and 20B do not necessarily have to be the same, and may be different from each other. For example, depending on the design requirements, the first reflective surface 20A may be larger than the second reflective surface 20B, or the second reflective surface 20B may be larger than the first reflective surface 20A.

Furthermore, the first and second reflective surfaces 20A and 20B are each illustrated as being formed in a shape having a curvature, but this is exemplary. They may each have a shape having a specific angle. For example, the first and second reflective surfaces 20A and 20B may each be designed to have a polygonal shape such as a triangle shape or a square shape.

Meanwhile, in the optical device 200 of FIGS. 4 to 10, the plurality of optical elements 20 are arranged such that the areas of the first and second reflective surfaces 20A and 20B appear to be the same when viewed from the front through the first surface 11, but this is exemplary. The arrangement of the first and second reflective surfaces 20A and 20B is not limited to this, and other arrangements may also be possible.

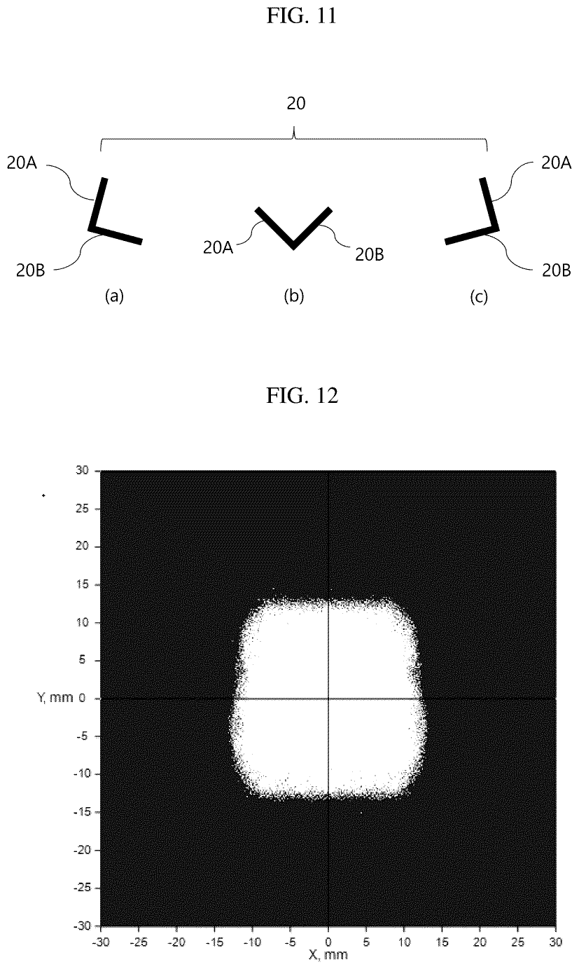

For example, among the plurality of optical elements 20 constituting the optical element array 20G, the optical elements 20 arranged in the central portion may be arranged such that the areas of the first and second reflective surfaces 20A and 20B appear to be the same, and the optical elements 20 arranged in the peripheral portions may be arranged in the state of being tilted such that the area of one of the surfaces appears to be smaller. For example, as shown in FIG. 11, the optical elements 20 arranged in the peripheral portions may be arranged such that they are tilted toward the center.

FIG. 11 is a diagram illustrating the tilting arrangement structure of optical elements 20, which shows a sectional view of the optical elements 20 viewed in the direction in which the boundary lines between the first and second reflective surfaces 20A and 20B of the optical elements 20 extend.

In FIG. 11, for ease of description, only three optical elements 20 are: shown, wherein FIG. 11(a) and 11(c) show optical elements 20 arranged on the left and right sides, and FIG. 11(b) shows an optical element 20 arranged at the center.

In a situation in which the optical elements 20 are arranged as shown in FIG. 11, in the case of the optical element 20 at the center shown in FIG. 11(b), the areas of the first and second reflective surfaces 20A and 20B appear to be the same when viewed from the front through the first surface 11 of the optical means 10. In the case of the optical elements 20 arranged on the left and right sides shown in FIG. 11(a) and 11(c), the areas of the first and second reflective surfaces 20A and 20B appear not to be the same.

That is, in the case of the optical element 20 of FIG. 11(a), the area of the second reflective surface 20B appears larger than that of the first reflective surface 20A. In the case of the optical element 20 of FIG. 11(c), the area of the first reflective surface 20A appears larger than that of the second reflective surface 20B.

In this manner, when the optical element array 20G is viewed from the front through the first surface 11, at least some of the plurality of optical elements 20 constituting the optical element array 20G may be arranged such that the area of one of the first and second reflective surfaces 20A and 20B of each of the some optical elements 20 appears smaller than the area of the other surface.

That is, when the optical element array 20G is viewed from the front through the first surface 11, the optical elements 20 arranged in the central portion among the plurality of optical elements 20 constituting the optical element array 20G are arranged such that the areas of the first and second reflective surfaces 20A and 20B appear to be the same. Furthermore, at least some of the optical elements 20 other than the optical elements 20 arranged in the central portion may be arranged in a form obtained by rotating the optical elements 20 arranged in the central portion around the boundary lines between the first and second reflective surfaces 20A and 20B.

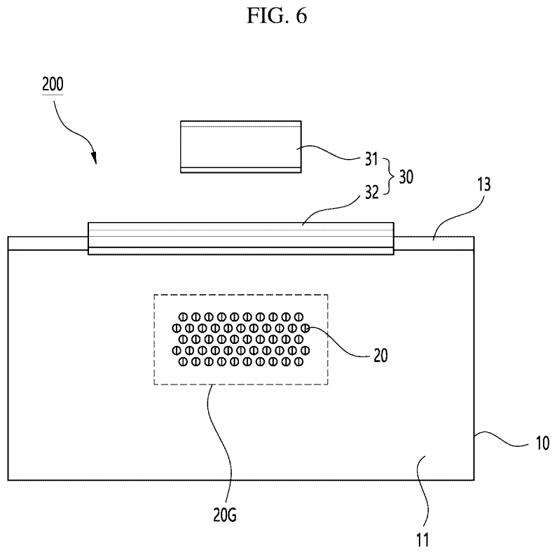

Meanwhile, as shown in FIG. 6, the optical elements 20 may each be formed to have a size smaller than the average human pupil size, i.e., 8 mm or less, preferably 4 mm or less, when the optical device 200 is placed in front of the pupil 40 and then viewed.

This may make the depth of field for the light incident on the pupil 40 considerably deep. Accordingly, there may be achieved a pinhole effect that allows a virtual image to be always recognized as being in focus regardless of a change in the focal length even when a user changes the focal length for the real world while gazing at the real world.

Meanwhile, when the size of the optical elements is excessively small, a diffraction phenomenon increases, so that the size of each of the optical elements is preferably equal to or larger than an appropriate size. For example, it is preferable that the size of each of the optical elements 20 be larger than 0.3 mm.

The optical elements 20 may be formed to appear circular when viewed from a plane. Furthermore, the optical elements 20 may be formed to appear circular when viewed from the pupil 40, as shown in FIG. 6, and to appear oval when viewed from a plane.

Meanwhile, the optical elements 20 are arranged such that the virtual image light transferred from the image output unit 30 is not blocked by other optical elements. For example, the optical elements 20 may be arranged to be positioned along a diagonal line or a gentle curve when the optical device 200 is viewed from a side, as shown in FIG. 4.

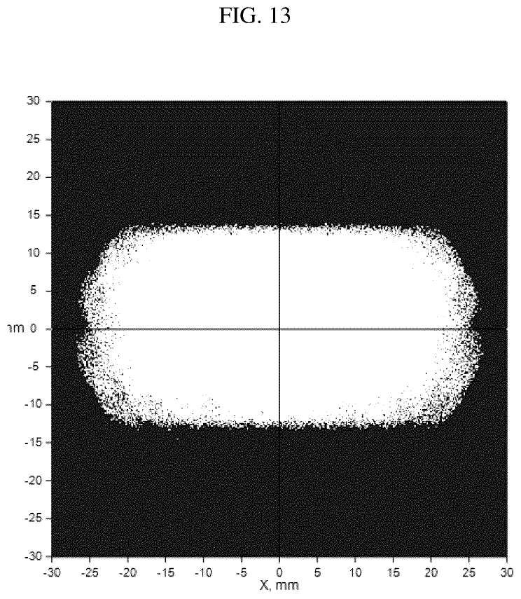

FIGS. 12 and 13 are diagrams showing the effects of the field of view and eyebox of an optical device 200 according to the present invention.

FIG. 12 is a screen in which the field of view of the conventional optical device 100, described with reference to FIGS. 1 to 3, in the horizontal axis-direction is actually measured, and FIG. 13 is a screen in which the field of view of the optical device 200 according to the present invention, described with reference to FIGS. 4 to 10, in the horizontal axis-direction is actually measured.

The screens of FIGS. 12 and 13 are screens in which the fields of view are measured when the light conversion unit 32 having the same size is employed. As shown in these drawings, it can be seen that the field of view of the optical device 200 according to the present invention in the horizontal-axis direction is significantly expanded compared to that of the conventional optical device 100.

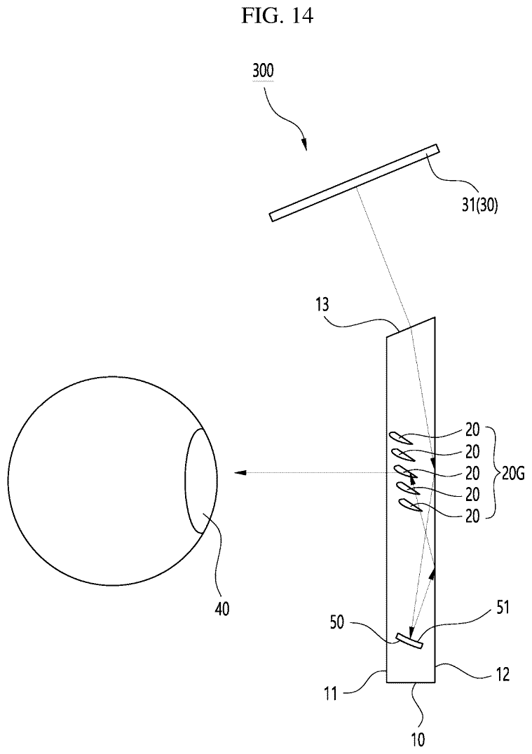

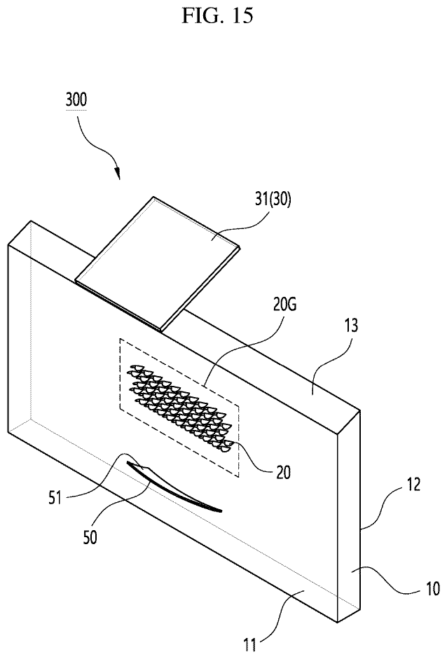

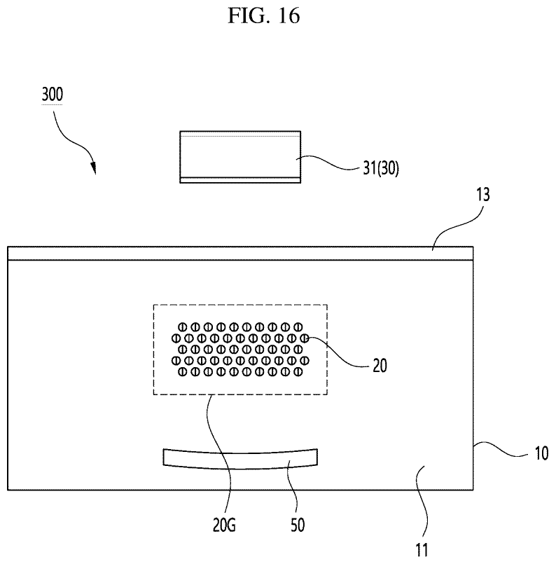

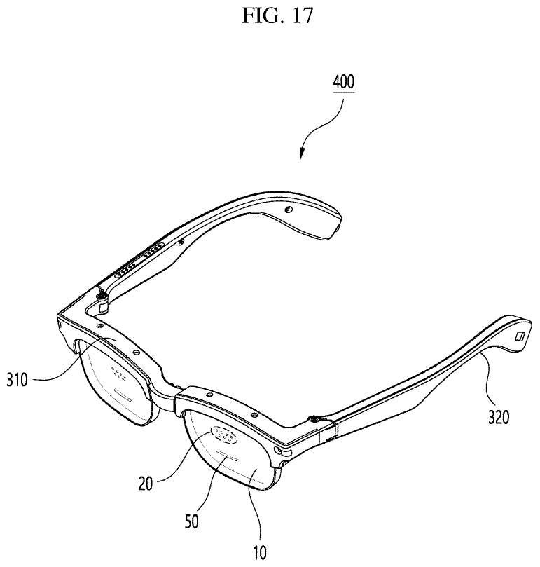

FIGS. 14 to 16 show a side view, perspective view, and front view, respectively, of an optical device 300 according to another embodiment of the present invention.

The optical device 300 of FIGS. 14 to 16 has the same basic configuration as the optical device 200 described above, except that an image output unit 30 does not include the light conversion unit 32 and an auxiliary optical element 50 that performs the function of the light conversion unit 32 is embedded and arranged inside an optical means 10.

The auxiliary optical element 50 performs a function similar to that of the light conversion unit 32 of the optical device 200. That is, the auxiliary optical element 50 is arranged in the optical means 10, and provides the function of converting and outputting the virtual image light, output from the image output unit 30, according to a preset optical path and focal length, thereby transferring it to optical elements 20.

For example, the auxiliary optical element 50 may be a reflective means that provides the function of a collimator that converts incident light into parallel light and outputs the parallel light.

Alternatively, the auxiliary optical element 50 may be a means such as a concave mirror that appropriately converts and then outputs incident light so that a virtual image can be enlarged or reduced according to preset design requirements.

The auxiliary optical 50 is embedded and arranged inside the optical means 10 in order to face the image output unit 30, as shown in the drawings.

The image output unit 30 outputs virtual image light toward the second surface 12 of the optical means 10, and the virtual image light reflected by total internal reflection on the second surface 12 of the optical means 10 is transferred to the auxiliary optical element 50.

The auxiliary optical element 50 reflects the incident virtual image light and outputs it toward the second surface 12 of the optical means 10, and the virtual image light reflected by total internal reflection on the second surface 12 is transferred to the optical element 20.

Thereafter, the optical element 20 transfers the incident virtual image light to the pupil 40, as described above.

Accordingly, the auxiliary optical element 50 is arranged at an appropriate location inside the optical means 10 between the first and second surfaces 11 and 12 of the optical means 10 by taking into consideration the relative locations of the image output unit 30, the optical elements 20, and the pupil 40.

In the optical device 300, the auxiliary optical element 50 is embedded and arranged inside the optical means 10 so that a reflective surface 51, on which the virtual image light is reflected and from which the virtual image light is output, faces the second surface 12 of the optical means 10. In this case, the straight line in the vertical direction from the center of the reflective surface 51 and the second surface 12 of the optical means 10 may be arranged to be inclined with respect to each other in order not to be parallel to each other.

However, this is exemplary. It is obvious that the auxiliary optical element 50 may be embedded and arranged inside the optical means 10 so that the reflective surface 51 of the auxiliary optical element 50 faces the first surface 11 of the optical means 10.

Meanwhile, the reflective surface 51 of the auxiliary optical element 50 may be formed as a curved surface. For example, the reflective surface 51 of the auxiliary optical element 50 may be formed to be concave in the direction of the second surface 12 of the optical means 10.

By this configuration, the auxiliary optical element 50 may perform the role of a light conversion unit 32 that converts virtual image light according to the design intention. Accordingly, there is no need to use a component such as the light conversion unit 32 in the image output unit 30.

Furthermore, it is preferable that the auxiliary optical element 50 appear thin when a user views a forward location through the pupil 40 so that the user rarely recognizes it.

Furthermore, it is preferable that the auxiliary optical element 50 be a reflective means.

It is preferable that the auxiliary optical element 50 be a full mirror, for example, made of metal, having a high reflectivity value of 100% or a value close thereto.

Furthermore, the auxiliary optical element 50 may be a half mirror that transmits a portion of incident light therethrough and reflects a portion of the incident light.

Furthermore, the auxiliary optical element 50 may be formed of any one of a refractive element, a diffractive element, and a holographic element, or a combination thereof.

Meanwhile, as shown in the drawing, when the optical device 300 is placed in front of the pupil 40, the auxiliary optical element 50 may be formed to extend in order to become closer to the image output unit 30 in the direction from the central portion toward each of the left and right ends.

That is, the auxiliary optical element 50 may be formed in the overall shape of a gentle “U”-shaped bar when the optical device 300 is placed in front of the pupil 40 and then viewed. This may further improve the function of the auxiliary optical element 50 that serves as the light conversion unit 32.

Since other components in the embodiments of FIGS. 14 to 16 are the same as those in the embodiments described above, detailed descriptions thereof will be omitted.

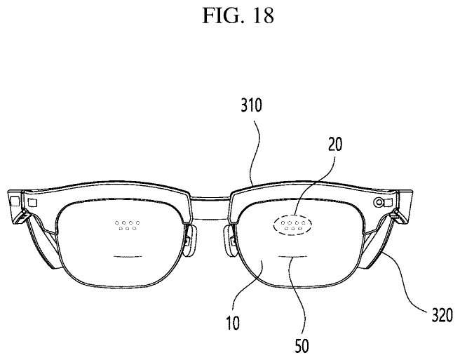

FIGS. 17 and 18 are diagrams showing an embodiment of a glasses-type augmented reality provision apparatus 400, which are a perspective view and front view of the augmented reality provision apparatus 300 including the optical devices 300 of FIGS. 14 to 16.

Referring to FIGS. 17 and 18, the augmented reality provision apparatus 400 includes the optical devices 300 such as that described above, a frame part 310, and fixation parts 320.

Each of the optical devices 300 includes an optical means 10, an auxiliary optical element 50, and optical elements 20, and the optical devices 300 are fixed to the frame part 310.

The frame part 310 may be formed in the shape of glasses that surround at least part of the periphery of each of the optical means 10, and image output units 30 may be embedded and arranged inside the frames 310.

The fixation parts 320 are coupled with the frame part 310, and are means that fix the optical devices 300 so that they can be worn on a user's face.

The fixation parts 320 may be formed in the shape of the temples of glasses that can be worn on the user's ears, as shown in the drawing.

Although not shown in the drawings, a connection port (not shown) that can be connected to a smartphone, a computer, or the like may be formed at an end of the fixation parts 320, and a data cable connected to the connection port and the image output units 30 may be arranged inside the fixation part 320 and the frame part 310. This may allow image or video data to be received through the connection port and also allow the received data to be transferred to the image output units 30.

As described above, according to the optical devices 200 and 300 of the present invention, it may be possible to make the device compact and lightweight while expanding the field of view and the eyebox. Accordingly, the augmented reality provision apparatus 400, such as that shown in FIGS. 17 and 18, may also be significantly reduced in size, thickness, and volume. As a result, it may be possible to provide the glasses-type augmented reality provision apparatus 400 having a shape similar to that of conventional glasses that is excellent in wearing comfort and minimizes unfamiliar sensation compared to the conventional technologies.

Although the augmented reality provision apparatus 400 including the optical devices 300 has been described in conjunction with FIGS. 17 and 18, the same applies to the optical device 200, so that a detailed description thereof is omitted.

Although the present invention has been described above with reference to the preferred embodiments of the present invention, this is exemplary. Those having ordinary skill in the art to which the present invention pertains may make various other modifications and variations within the scope of the present invention determined by the attached claims and the accompanying drawings. It should be noted that such modifications and variations may all be included in the equivalent ranges of the present invention.

1. An optical device for augmented reality having an expanded field of view and eyebox, the optical device comprising:
an image output unit including a display unit configured to output virtual image light, and a light conversion unit configured to convert and then output the virtual image light according to preset requirements;
an optical means configured to allow the virtual image light, output from the image output unit, to propagate through an inside thereof, and to transmit real object image light therethrough toward a user's pupil; and
a plurality of optical elements arranged in the optical means to transfer the virtual image light, transferred from the image output unit, toward the user's pupil;
wherein each of the plurality of optical elements includes a first reflective surface and a second reflective surface, which are a pair of reflective surfaces arranged to be inclined with respect to each other; and
wherein the first and second reflective surfaces are arranged at an inclination angle such that each of the first and second reflective surfaces transfers virtual image light, transferred from the image output unit, to the other reflective surface and transfers virtual image light, transferred from the other reflective surface, toward the user's pupil.

2. The optical device of claim 1, wherein the inclination angle between the first and second reflective surfaces is between 60° and 120°.

3. The optical device of claim 1, wherein the inclination angle between the first and second reflective surfaces is 90°.

4. The optical device of claim 1, wherein the first and second reflective surfaces are arranged with a gap therebetween.

5. The optical device of claim 1, wherein the plurality of optical elements are formed such that, when the optical device for augmented reality is placed in front of the pupil and then viewed, among the first and second reflective surfaces, the heights of those located in the direction from the center toward one side along the horizontal-axis gradually increase along that direction.

6. The optical device of claim 1, wherein the plurality of optical elements are formed such that, when the optical device for augmented reality is placed in front of the pupil and then viewed, among the first and second reflective surfaces, the heights of those opposite to reflective surfaces located in the direction from the center toward one side along the horizontal-axis gradually decrease along that direction.

7. The optical device of claim 1, wherein the plurality of optical elements are arranged at intervals such that they appear as a two-dimensional array when the optical device for augmented reality is placed in front of the pupil and then viewed.

8. The optical device of claim 1, wherein the plurality of optical elements are arranged such that, when the optical device for augmented reality is placed in front of the pupil and then viewed, an area of one of first and second reflective surfaces of at least some of the plurality of optical elements appears smaller than that of a remaining surface.

9. The optical device of claim 8, wherein, among the plurality of optical elements, optical elements arranged in a central portion when the optical device for augmented reality is placed in front of the pupil and then viewed are arranged such that areas of the first and second reflective surfaces appear to be the same, and at least some of optical elements other than the optical elements arranged in the central portion are arranged in a form obtained by rotating the optical elements arranged in the central portion around boundary lines between the first and second reflective surfaces.

10. The optical device of claim 1, wherein:
the optical means has a first surface configured such that virtual image light and real object image light are output toward the user's pupil therethrough, and a second surface configured such that it faces the first surface and real object image light is incident thereon; and
the virtual image light output from the image output unit is reflected by total internal reflection on the second surface of the optical means and transferred to the optical elements.

11. The optical device of claim 10, wherein each of the plurality of optical elements is arranged to be inclined inside the optical means so that it can transfer the virtual image light, transferred by total internal reflection on the second surface of the optical means, to the user's pupil.

12. The optical device of claim 1, wherein each of the plurality of optical elements is 4 mm or less in size when the optical device for augmented reality is placed in front of the pupil and then viewed.

13. The optical device of claim 1, wherein each of the plurality of optical elements is a reflective means that reflects incident light.

14. The optical device of claim 1, wherein at least some of the plurality of optical elements are half mirrors that transmit a portion of incident light therethrough and reflect a portion of the incident light.

15. The optical device of claim 1, wherein at least some of the plurality of optical elements are each formed of any one of a refractive element, a diffractive element, and a holographic element, or a combination thereof.

16. An optical device for augmented reality having an expanded field of view and eyebox, the optical device comprising:
an image output unit including a display unit configured to output virtual image light;
an optical means configured to allow the virtual image light, output from the image output unit, to propagate through an inside thereof, and to transmit real object image light therethrough toward a user's pupil;
an auxiliary optical element arranged in the optical means, and configured to convert the virtual image light, output from the image output unit, according to preset requirements and to output the virtual image light so that it is transferred to a plurality of optical elements; and
the plurality of optical elements arranged in the optical means to transfer the virtual image light, transferred from the auxiliary optical element, toward the user's pupil;
wherein each of the plurality of optical elements includes a first reflective surface and a second reflective surface, which are a pair of reflective surfaces arranged to be inclined with respect to each other; and
wherein the first and second reflective surfaces are arranged at an inclination angle such that each of the first and second reflective surfaces transfers virtual image light, transferred from the image output unit, to a remaining reflective surface and transfers virtual image light, transferred from the remaining reflective surface, toward the user's pupil.

17. The optical device of claim 16, wherein the auxiliary optical element is embedded and arranged inside the optical means in order to face the image output unit.

18. The optical device of claim 16, wherein:
the optical means has a first surface configured such that virtual image light and real object image light are output toward the user's pupil therethrough, and a second surface configured such that it faces the first surface and real object image light is incident thereon;
the virtual image light output from the image output unit is reflected by total internal reflection on the second surface of the optical means and transferred to the auxiliary optical element; and
the virtual image light output from the auxiliary optical element is reflected by total internal reflection on the second surface of the optical means and transferred to the optical elements.

19. The optical device of claim 18, wherein the plurality of optical elements are arranged to be inclined inside the optical means so that they can transfer virtual image light, transferred by total internal reflection on the second surface of the optical means, to the user's pupil.

20. The optical device of claim 16, wherein the auxiliary optical element is a reflective means that reflects incident light.

21. The optical device of claim 20, wherein the auxiliary optical element is a half mirror that transmits a portion of incident light therethrough and reflects a portion of the incident light.

22. The optical device of claim 16, wherein the auxiliary optical element is formed of any one of a refractive element, a diffractive element, and a holographic element, or a combination thereof.

23. The optical device of claim 16, wherein the auxiliary optical element is formed such that, when the optical device for augmented reality is placed in front of the pupil and then viewed, the auxiliary optical element is formed to extend in order to become closer to the image output unit in a direction from a central portion thereof toward left and right ends thereof.

24. The optical device of claim 16, wherein the inclination angle between the first and second reflective surfaces is between 60° and 120°.

25. The optical device of claim 16, wherein the inclination angle between the first and second reflective surfaces is 90°.

26. The optical device of claim 16, wherein the first and second reflective surfaces are arranged with a gap therebetween.

27. The optical device of claim 16, wherein the plurality of optical elements are formed such that, when the optical device for augmented reality is placed in front of the pupil and then viewed, among the first and second reflective surfaces, the heights of those located in the direction from the center toward one side along the horizontal-axis gradually increase along that direction.

28. The optical device of claim 16, wherein the plurality of optical elements are formed such that, when the optical device for augmented reality is placed in front of the pupil and then viewed, among the first and second reflective surfaces, the heights of those opposite to reflective surfaces located in the direction from the center toward one side along the horizontal-axis gradually decrease along that direction.

29. The optical device of claim 16, wherein the plurality of optical elements are arranged at intervals such that they appear as a two-dimensional array when the optical device for augmented reality is placed in front of the pupil and then viewed.

30. The optical device of claim 16, wherein the plurality of optical elements are arranged such that, when the optical device for augmented reality is placed in front of the pupil and then viewed, an area of one of first and second reflective surfaces of at least some of the plurality of optical elements appears smaller than that of a remaining surface.

31. The optical device of claim 30, wherein, among the plurality of optical elements, optical elements arranged in a central portion when the optical device for augmented reality is placed in front of the pupil and then viewed are arranged such that areas of the first and second reflective surfaces appear to be the same, and at least some of optical elements other than the optical elements arranged in the central portion are arranged in a form obtained by rotating the optical elements arranged in the central portion around boundary lines between the first and second reflective surfaces.

32. The optical device of claim 16, wherein each of the plurality of optical elements is 4 mm or less in size when the optical device for augmented reality is placed in front of the pupil and then viewed.

33. The optical device of claim 16, wherein the plurality of optical elements are reflective means that reflect incident light.

34. The optical device of claim 16, wherein at least some of the plurality of optical elements are half mirrors that transmit a portion of incident light therethrough and reflect a portion of the incident light.

35. The optical device of claim 16, wherein at least some of the plurality of optical elements are each formed of any one of a refractive element, a diffractive element, and a holographic element, or a combination thereof.

36. A glasses-type augmented reality provision apparatus, comprising:
optical devices for augmented reality set forth in claim 1;
a frame part configured such that the optical devices for augmented reality are fixed thereto; and
fixation parts configured to be coupled to the frame part and fix the optical devices for augmented reality so that they can be worn on a user's face.

37. A glasses-type augmented reality provision apparatus, comprising:
optical devices for augmented reality set forth in claim 16;
a frame part configured such that the optical devices for augmented reality are fixed thereto; and
fixation parts configured to be coupled to the frame part and fix the optical devices for augmented reality so that they can be worn on a user's face.
